(19) United States
(12) Patent Application Publication
(10) Pub. No.: US 2016/0156258 A1
(43) Pub. Date: Jun. 2, 2016

(54) POWER SOURCE CONTROL DEVICE AND METHOD FOR DETECTING RELAY ABNORMALITY

(71) Applicant: CALSONIC KANSEI CORPORATION, Saitama (JP)

(72) Inventor: Tetsuya Yokoyama, Saitama (JP)

(21) Appl. No.: 14/906,107

(22) PCT Filed: Mar. 28, 2014
(86) PCT No.: PCT/JP2014/059299

§ 371 Date: Jan. 19, 2016

(30) Foreign Application Priority Data
Jul. 19, 2013 (JP) 2013-150273

(51) Int. Cl. H02M 1/00; H02M 7/44; H02M 3/04

(52) U.S. Cl. CPC H02M 1/00; H02M 3/04; H02M 7/44; H02M 2001/0003

(57) ABSTRACT

A power supply control device includes a discharge speed reducing unit 3 for reducing a discharge speed of discharge current flowing to a converter 6 from a capacitive element C1. The power supply control device controls the converter 6 so as to charge the capacitive element C1 to a predetermined voltage higher than a voltage of a first DC power supply, and thereafter in a state that first and second relays SMR1, SMR2 are placed in a mutually opposite on/off state, determine whether or not at least one of the both relays is abnormal based on change of a voltage value detected by a voltage sensor 4.

### TECHNICAL FIELD

The present invention relates to a power supply control device and a method of detecting abnormality of a relay, each of which can diagnose presence or absence of abnormality of a control relay as a system relay for a power supply circuit.

### BACKGROUND ART

As a power supply control device and a method of detecting abnormality of a relay of a related art, there is known those described in a patent document 1.

The power supply control device of this related art includes: a first relay connected between one electrode of a DC power supply and a first power line; a second relay connected between the other electrode of the power supply and a second power line; a capacitive element (capacitor) connected between the both power lines; a bidirectional converter connected between the both power lines in parallel to the capacitive element; a voltage detection unit for detecting a terminal voltage across the capacitive element; and a control unit for controlling the bidirectional converter so as to charge the capacitive element using the bidirectional converter.

In this method of detecting abnormality of a relay, the control unit divides charging of the capacitive element into two stages, and controls the bidirectional converter to charge (precharge) the capacitive element to a predetermined voltage lower than a voltage of the DC power supply in the first stage upon turning-on of an ignition switch. Thereafter the control unit turns the first and second relays to an on state and an of state, respectively, and determines whether or not the second relay in the off state is welded based on a change of a voltage value across both terminals of the capacitive element at that time.

That is, if the relay is welded, as the voltage increases when only a contact on the opposite side is closed, the determination of the welding is performed by detecting this voltage increase.

Next, in a second stage upon turning-off of the ignition switch, after the capacitive element is charged to a voltage level of the DC power supply, the control device switches the first and second relays to an off state and an on state, respectively, then controls the bidirectional DC/DC converter to discharge the capacitive element, and determines whether or not the first relay is welded based on a change in the detected voltage value at that time.

### RELATED DOCUMENTS

### Patent Documents

Patent Document 1: Japanese Patent No. 4,788,461

### SUMMARY OF THE INVENTION

### Problems that the Invention is to Solve

However, the power supply control device and the method of detecting abnormality of a relay of the related art has problems explained below.

In the power supply control device and the method of detecting abnormality of a relay of the related art, if high-voltage electric charge remains in the capacitive element in an unused state, such the electric charge is unfavorable at a time of performing a maintenance operation, etc. Thus, after stopping a system, the electric charge of the capacitor is discharged to an auxiliary-equipment power storage unit using the bidirectional DC/DC converter.

In this case, there arises a problem that the discharging process cannot be performed in a case that the bidirectional DC/DC converter becomes failure.

On the other hand, as this kind of the power supply control device, there is known one in which a resistor for discharge is provided as a discharge path connected between both ends of the capacitive element. In this case, although the discharging process can be performed even in a case that the bidirectional DC/DC converter becomes failure, the following problem occurs.

That is, in the control of the power supply control device of the related art described in the patent document 1, in order to suppress a rush current flowing to the capacitive element, it is necessary to inject electric charge to the capacitive element from the converter (bidirectional DC/DC converter or the like) side before tuning-on of the relays to thereby increase the charged voltage to the voltage of the DC power supply. If this control is not performed, the relay may be fused or a life time of the capacitor may be shortened due to the rush current generated upon the turning-on of the relays. Although it is desirable to set the charged voltage in the vicinity of the voltage of the DC power supply in order to possibly reduce the rush current, the charged voltage cannot be set to this vicinity by the following reason.

In this manner, if the discharge resistor is additionally provided in the power supply control device described in the patent document 1, the discharging process can be performed even in a case that the bidirectional DC/DC converter becomes failure. However, as the discharging via this discharge resistor is performed always, the charged voltage reduces gradually even if the charging is performed by the converter.

In this case, it is necessary to, after charging the capacitive element by the converter, switch the on/off state of the relays and diagnose the welding of the relay. As a time period for the diagnosis is also required, the charged voltage further reduces during this time period. As a result, a magnitude of the rush current generated at a time of the turning-on of the power supply according to a formal connection performed by the turning-on of the relays becomes large, and hence a load on the relays and the capacitor becomes large.

Therefore, the invention, having been contrived bearing in mind the heretofore described problems, has for its object to provide a power supply control device and a method of detecting abnormality of a relay which can perform a discharging process even in a case that a bidirectional DC/DC converter becomes failure, and also, in this case, can eliminate the aforesaid problem that a large current flows abruptly into relays to thereby prevent increase of a load applied to contacts of the relays and a capacitor.

### Means for Solving the Problems

In order to attain this object, a power supply control device comprising:

a first DC power supply and a second DC power supply;

a first power line and a second power line;

a first relay which connects between one electrode of the first DC power supply and the first power line;

a second relay which connects between the other electrode of the first DC power supply and the second power line;

a capacitive element which connects between the first power line and the second power line;

a converter which is connected between the first and second power lines and the second DC power supply;

a discharge speed reducing unit which reduces a discharge speed of discharge current flowing to the converter from the capacitive element;

a voltage sensor which detects a voltage between both terminals of the capacitive element; and

a control unit which controls switching of each of the first and second relays, controls an operation of the converter, and determines whether or not the first relay or the second relay is abnormal based on a voltage signal inputted from the voltage sensor, wherein

the control unit controls the converter so as to charge the capacitive element to a predetermined voltage higher than a voltage of the first DC power supply, and thereafter in a state that the first and second ⁻days placed in a mutually opposite on/off state and the converter is turned off, determines whether or not one of the first and second relays in the off state is abnormal based on change of a voltage value detected by the voltage sensor.

Further, a method of detecting abnormality of a relay for a power supply control device including:

a first DC power supply and a second DC power supply;

a first power line and a second power line;

a first relay which connects between one electrode of the first DC power supply and the first power line;

a second relay which connects between the other electrode of the first DC power supply and the second power line;

a capacitive element Which connects between the first power line and the second power line;

a converter which is connected between the first and second power lines and the second DC power supply;

a discharge speed reducing unit which reduces a discharge speed of discharge current flowing to the converter from the capacitive element;

a voltage sensor which detects a voltage between both terminals of the capacitive element; and

a control unit which controls switching of each of the first and second relays, controls an operation of the converter, and determines whether or not the first relay or the second relay is abnormal based on a voltage signal inputted from the voltage sensor, the method includes:
controlling the converter so as to charge the capacitive element to a predetermined voltage higher than a voltage of the first DC power supply; and

thereafter in a state that the first and second relays are placed in a mutually opposite on/off state and the converter is turned off, determining whether or not one of the first and second relays in the off state is abnormal based on change of a voltage value detected by the voltage sensor.

### Advantages of the Invention

The power supply control device according to the invention can perform the discharging process even in a case that a bidirectional DC/DC converter heroine failure. Further, in this case, the power supply control device can prevent a phenomenon that a rush current, generated upon turning-on of the relays according to a formal connection after sure execution of an abnormality diagnosis of the relay, becomes large and hence a load applied to contacts of the relays and a capacitor becomes large.

Further, the method of detecting abnormality of the relay according to the invention can prevent a phenomenon that a rush current, generated upon turning-on of the relays according to the formal connection after sure execution of the abnormality diagnosis of the relay, becomes large and hence a load applied to the contacts of the relays and the capacitor becomes large.

### BRIEF DESCRIPTION OF THE DRAWINGS

FIG. 1 is a block diagram showing configuration of a power supply control device according to an embodiment of the invention.

FIG. 2 is a diagram showing change of voltage at a time of inspection of abnormality of a relay in the power supply control device according to the embodiment.

FIG. 3 is a diagram showing change of voltage at a time of inspection of abnormality of a relay in a related art.

### MODES FOR CARRYING OUT THE INVENTION

Hereinafter, a mode for carrying out the invention according to the invention will be explained in detail based on an embodiment shown in drawings.

Embodiment

Firstly an entire configuration of a power supply control device according to the embodiment will be explained.

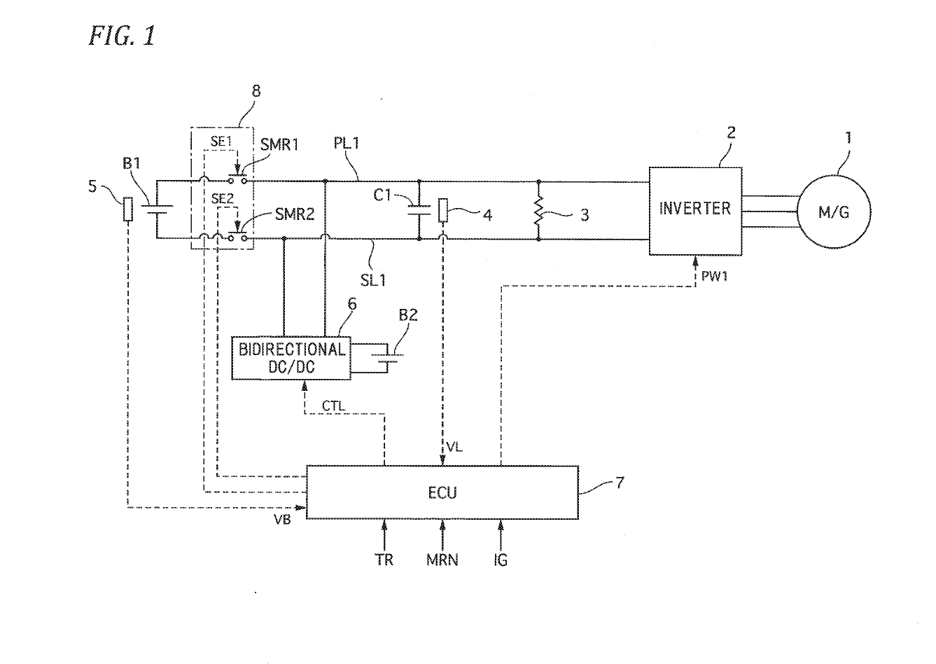

As shown in FIG. 1, the power supply control device according to the embodiment includes a main power storage unit B1, a resistor 3, a first voltage sensor 4, a second voltage sensor 5, a bidirectional DC/DC converter 6, an electronic control unit (ECU) 7, a system main relay 8, an auxiliary-equipment power storage unit B2, a power supply line KA and a ground line SL1. The power supply control device is connected to a motor/generator (M/G) 1 via, an inverter 2.

In the embodiment, these elements are mounted in an electronic car or a hybrid car.

The main power storage unit B1 is a secondary battery such as a lithium ion battery configured of, for example, a package constituted of serially connected many cells. The auxiliary-equipment power storage unit B2 is a battery capable of, for example, supplying power to a not-shown auxiliary equipment or the like and, in contrast, charging power.

The main power storage unit B1 corresponds to a first DC power supply according to the invention and the auxiliary-equipment power storage unit B2 corresponds to a second DC power supply according to the invention.

The motor/generator 1 is constituted of for example, a three-phase AC motor and acts as a motor during a period of being supplied with power from the inverter 2 to thereby drive a vehicle, During a braking operation, etc., the motor/generator acts as a generator in a manner of performing a regeneration operation of converting brake energy into electric energy, thereby transmitting the regenerated power to the inverter 2 or utilizing the regenerated power for charging the main power storage unit B1.

The inverter 2 generates three-phase currents according to a control signal sent from the electronic control unit 7 and supplies the respective three-phase currents to three-phase windings of the motor/generator 1. Further, during energy regeneration, the inverter converts AC current transmitted from the three-phase windings of the motor/generator 1 into DC current and transmits the DC current to the main power storage unit B1.

A capacitor C1 (capacitive element and the resistor 3 are arranged in parallel and are connected between the power supply line PL1 and the ground line SL1.

The capacitor C1 smooths voltage fluctuation between the power supply line P1 and the ground line SL1.

On the other hand, the resistor 3 is set to have a large resistance value and so, during discharging of the capacitor C1, flow a small current slowly between the both lines PL1 and SL1 so as to reduce a discharge speed of discharge current from the capacitor C1.

Incidentally, the resistor 3 corresponds to a discharge speed reducing unit acc riding to the invention.

The first voltage sensor 4 detects a voltage between both terminals of the capacitor C1 and supplies a voltage signal VL of thus detected voltage to the electronic control unit 7.

On the other hand, the second voltage sensor 5 detects a voltage between both terminals of the main power storage unit B1 and supplies a voltage signal VB of thus detected voltage to the electronic control unit 7.

Incidentally, the first voltage sensor 4 corresponds to a voltage sensor according to the invention.

The bidirectional DC/DC converter 6 is connected between the power supply line PL the ground line SL1 and the auxiliary-equipment power storage unit B2, and convers a voltage value of a DC current flowing from the former to the latter to a corresponding value and also convers a voltage value of a DC current flowing in the opposite direction to a corresponding value. In other words, the voltage value is increased in the case of flowing the current from the former to the latter whilst reduced in the case of flowing the current in the opposite direction.

The electronic control unit 7 is constituted of, for example, a microcomputer. The electronic control unit inputs the voltage signal VL representing a voltage value of the capacitor C1 detected by the first voltage sensor 4, the voltage signal VB representing a terminal voltage of the main power storage unit B1 detected by the second voltage sensor 5, a torque command value signal TR of the motor/generator 1 and its rotation speed signal MRN from a not-shown external ECU, and an ignition on/off signal IG from a not-shown ignition.

Then the electronic control unit 7 outputs, based on these signals, a pulse width modulation signal PW1 to the inverter 2 so as to generate power to be supplied to the motor/generator 1 and also outputs, to the bidirectional DC/DC converter 6, a control signal CTL for controlling this converter.

Further, the electronic control unit outputs relay signals SE1 and SE2 to turn on/off a first relay SMR1 and a second relay SMR2, respectively.

Incidentally, the electronic control unit 7 corresponds to a control unit according to the invention.

The system main relay 8 includes the first relay SMR1 and the second relay SMR2.

The first relay SMR1 is provided between a positive electrode of the main power storage unit B1 and the power supply line PL1. The second relay SMR2 is provided between a negative electrode of the main power storage unit B1 and the ground line SL1. These relays are connected upon turning-on of a system and disconnected upon turning-off of the system.

However, at a time of executing the method of detecting abnormality of the relay according to the invention, the first relay SMR1 and the second relay SMR2 are controlled in a manner that one of these relays is placed in an on state and the other is placed in an off state.

The power supply line PL1 connects between the first relay SMR1 and a positive side terminal of the inverter 2. The ground line SL1 connects between the second relay SMR2 and a negative side terminal of the inverter 2.

Incidentally, one of the power supply line PL1 and the ground line SL1 corresponds to a first power line according to the invention and the other corresponds to a second power line according to the invention.

As explained later, if electric charge remains in the capacitor C1 after the ignition switch is turned off, inconvenience occurs in a maintenance work. Thus, like the case of the related art, in the power supply device configured in this manner, the electronic control unit 7 drives the bidirectional DC/DC converter 6 when the signal IG from the ignition switch is turned off, thereby flows electric charge accumulated in the capacitor C1 to the bidirectional DC/DC converter 6 to change the voltage value, and thus charges the auxiliary-equipment power storage unit B2.

In this embodiment, in addition to the configuration of the related art, the resistor 3 is connected in parallel to the capacitor C1 between the power supply line PL1 and the ground line SL1. As the resistor 3 is set to have the large resistance value, electric charge can be discharged from the capacitor C1 via the resistor 3 having the large resistance value even in a case that the bidirectional DC/DC converter 6 does not operate normally.

As the resistor 3 for discharge is added in this manner, electric charge can be discharged from the capacitor C1 even in a case that the bidirectional DC/DC converter 6 does not operate normally. However, due to the addition of the resistor 3, the following new problem arises upon inspection of abnormality detection of the relays.

In view of this, in the method of detecting abnormality of the relay according to the embodiment, both a precharge voltage value and a threshold value for the abnormality determination are made differ from those of the method. of detecting abnormality of relays according to the related art.

This will be explained below concretely.

Firstly, explanation will be made with reference to FIG. 3 as to a case that the resistor 3 is added to the device of the related art like this embodiment and then the abnormality detection method same as that of the related art is executed. However, in order to facilitate the explanation, a boost converter is eliminated.

That is, in this case, at a time of the inspection of the first stage performed in a turned-on state of the ignition switch, the capacitor is precharged by the bidirectional DC/DC converter. However, there is a slight error in a voltage value upon the precharging and a voltage value upon a formal connection. Thus, confirmation upon measurement can be facilitated if a voltage value upon abnormality detection is made differ by a certain value or more from a charged voltage value upon the formal connection (the terminal voltage VB of the main power storage unit B1 in the embodiment).

In contrast, in a case of connecting the relays in order to perform formal charging, it is desired to reduce a load on contact points of the relays, etc. by reducing a rush current upon the turning-on of the relays. Thus, a difference between the voltage value upon the precharging and the charged voltage value upon the formal connection is desired to be small.

To this end, as shown in FIG. 3, in the method of detecting abnormality of the relay according to the related art a predetermined voltage Vth1 precharged by the bidirectional DC/DC converter is set to a value lower by a certain value than the voltage VB of the main power storage unit B1. Further, a threshold value Vth2 for determining abnormality to be compared with a voltage value VL detected by the voltage sensor is set to an intermediate value therebetween.

Then, as described above, in order to perform the measurement in view of the error, the three voltage values VB, Vth1 and Vth2 (Vth1 <Vth2 <VB) are required to have a difference of a certain level thereamong.

The method of detecting abnormality of the relays is performed under this condition. That is, as shown in FIG. 3 (an abscissa and an ordinate represent time and voltage value respectively), detection of presence/non-presence of abnormality of the second relay is started in the turning-on state of the ignition switch based on the relation among the respective voltages.

While keeping each of the first and second relays in an off state after a time point t1, driving of the bidirectional DC/DC converter is started and thus precharging of the capacitive element is started by the auxiliary-equipment power storage unit. As a result, the voltage value VL of the capacitive element increases gradually.

When the voltage value VL reaches the preset voltage value Vth1 at a time point t2, the driving of the bidirectional DC/DC converter is turned off. Next, the first relay is turned on with the second relay kept in an off state.

Then, during a period from the time point t2 to a predetermined time point t3, comparison is made between the voltage value VL and the threshold voltage Vth2 in view of change of this voltage value, and thus diagnostic determination is made whether or not the second relay is abnormal (welded). It is determined that the second relay is welded in a case that the detected voltage value VL is higher than the threshold voltage Vth2, whilst it is determined that the second relay is normal in a case that the detected voltage value is lower than this threshold voltage.

If it is determined that the second relay is normal, the second relay is also turned on, and thus the voltage VB is applied to the capacitor, etc. via the relays from the main power storage unit.

However, if the resistor for discharge is added to the main power storage unit, discharge current flows via this resistor during the inspection of abnormality performed by the voltage value comparison. Thus, as shown in FIG. 3, the voltage drops by ΔV1 during the period between the time points t2 and t3, and hence becomes lower than the voltage value Vth1 precharged by the bidirectional DC/DC converter.

As a result, upon the formal connection at the time point t3, rush current flows into the capacitor and the relays with a large voltage difference shown by ΔV2 in FIG. 3. Thus, durability of these elements degrades.

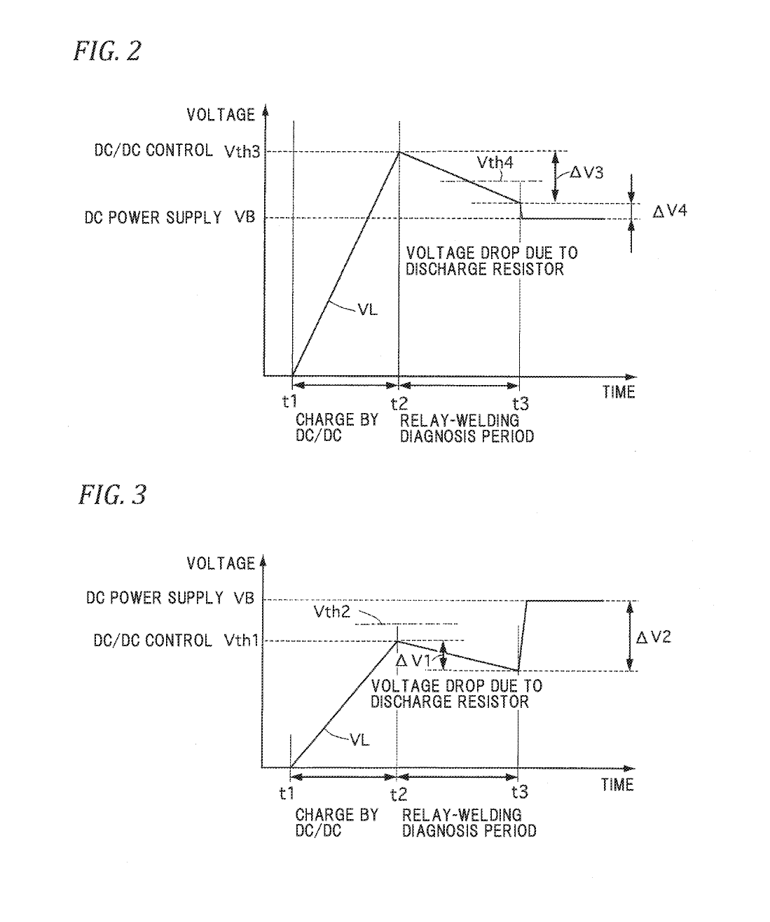

In view of this, in the method of detecting abnormality of the relays in the power supply control device according to the embodiment, as shown in FIG. 2, in a state of placing each of the first and second relays in an off state, driving of the bidirectional DC/DC converter 6 is started at the time point t1 and thus precharging of the capacitive element is started. However, unlike the related art, the charged voltage increases to a value Vth3 which is set to be higher than the terminal voltage VB of the main power storage unit B1.

At a time point t2 (different from t2 of the related art), driving of the bidirectional DC/DC converter 6 is stopped and further the first relay SMR1 is turned on While keeping the second relay SMR2 in an off state. A voltage value VL of the capacitor C1 measured at this time by the first voltage sensor 4 is compared with a threshold value Vth4.

These values has a relation of VB <Vth4 <Vth3. Even if each of these values has an error, these values are set to have magnitudes capable of determination and not to have a large difference thereamong.

Thus, the measured voltage value VL reduces gradually due to discharge via the resistor 3. Then if the measured voltage value becomes equal to or lower than the threshold value Vth4, it is determined to be normal. In contrast, if the measured voltage value remains higher than the threshold value Vth4, it is determined to be abnormal (determined that the second relay SMR2 is welded).

If it is determined to be abnormal, a countermeasure processing of the abnormality is performed. For example, a warning is issued or the turning-on operation of the system main relay 8 is inhibited.

In contrast, if it is determined to be normal, the formal connection is performed. That is, when the second relay SMR2 is switched in an on state from an off state, as the main power storage unit B1 is electrically connected to the power supply line PL1 and the ground line SL1, the voltage value VB of this power storage unit is applied to the inverter 2.

In this formal connection, as the voltage value VL reduces by ΔV3 from the voltage value Vth3 upon the precharging due to the discharge via the resistor 3, rush current flows based on a small voltage difference of ΔV4 at this time. Therefore, damage to the system main relay 8, the capacitor C1, etc. can be suppressed.

On the other hand, when the turning-off of the ignition switch is detected, determination of abnormality of the first relay SMR1 is performed in the similar manner as the related art.

In this manner in the power supply control device and the method of detecting abnormality of the relay according to the embodiment arranged in this manner, the resistor 3 having the large resistance value is provided so as to reduce the discharge speed upon discharging of the capacitor C1. Thus, even in a case that the bidirectional DC/DC converter 6 does not operate normally, discharge of the capacitor 1 can be performed via the resistor 3.

Further, in this case, as the resistor 3 is added, the voltage value VL across the both terminals of the capacitor C1 reduces during the abnormality diagnosis. In the embodiment, the resistance value of the resistor 3 is increased so as to reduce the discharge speed. In addition, the predetermined voltage value Vth3 of the capacitor C1 precharged by the bidirectional DC/DC converter 6 is made higher than the voltage value VB of the main power storage unit B1, and then compared with the threshold value Vth4. By doing so, the voltage difference ΔV3 between the voltage value VL upon the formal connection and the voltage value VB of the main power storage unit B1 be suppressed to a small value. As a result, a magnitude of rush current generated at the time of turning-on of the relay second relay SMR2 in this embodiment), paced in an off-state during the inspection, can be suppressed to a small value. Therefore adverse effect (life time, etc, on the relays and the capacitor can be suppressed.

Further, in the power supply control device and the method of detecting abnormality of the relay according to the embodiment, the discharge speed reducing unit is realized by the resistor 3 which is connected between the power supply line PL1 (first power line) and the ground line SL1 (second power line) and also connected in parallel to the capacitor C1 (capacitive element), abrupt flowing of a large current into the converter can be suppressed cheaply and simply.

A description has been given of the invention based on the embodiment, but the invention is not limited to the embodiment. The invention contains design changes, etc. of the embodiment within a range not departing from the gist of the invention.

For example, although the resistor 3 is used as the discharge speed reducing unit, another element may be used so long as the element can suppress such a phenomenon that a large discharge current from the capacitor C1 flows abruptly into the bidirectional DC/DC converter 6.

Further, like the related art, a boost converter may be arranged between the inverter 2 and the system main relay 8.

Furthermore, an application field of the power supply control device and the method of detecting abnormality of the relay according to the invention is not limited to an electronic car or a hybrid car, but may be other equipments.

The present application is based on Japanese Patent Application (Japanese Patent Application No. 2013-150273) filed on Jul. 19, 2013, the entire contents of which are incorporated herein by reference. Further, all references cited therein are entirely incorporated.

### DESCRIPTION OF REFERENCE NUMERALS AND SIGNS

1 motor/generator

2 inverter

3 resistor (discharge speed reducing unit)

4 first voltage sensor (voltage sensor)

5 second voltage sensor

6 bidirectional DC/DC converter (converter)

7 electronic control unit (control unit)

8 system main relay

B1 main power storage unit (first DC power supply)

B2 auxiliary-equipment power storage unit (second DC power supply)

PL1 power supply line (first power line)

SL1 ground line (second power line)

SMR1 first relay

SMR2 second relay

1. A power supply control device comprising:
a first DC power supply and a second DC power supply;
a first power line and a second power line;
a first relay which connects between one electrode of the first DC power supply and the first power line;
a second relay which connects between the other electrode of the first DC power supply id the second power line;
a capacitive element which connects between the first power line and the second power line;
a converter which is connected between the first and second power lines and the second DC power supply;
a discharge speed reducing unit which reduces a discharge speed of discharge current flowing to the converter from the capacitive element;
a voltage sensor which detects a voltage between both terminals of the capacitive element; and
a control unit which controls switching of each of the first and second relays, controls an operation of the converter, and determines whether or not the first relay or the second relay is abnormal based on a voltage signal inputted from the voltage sensor, wherein
the control unit controls the converter so as to charge the capacitive element to a predetermined voltage higher than a voltage of the first DC power supply, and thereafter in a state that the first and second relays placed in a mutually opposite on/off state and the converter is turned off, determines whether or not one of the first and second relays in the off state is abnormal based on change of a voltage value detected by the voltage sensor.

2. The power supply control device according to claim 1, wherein
the discharge speed reducing unit is a resistor which is connected between the first power line and the second power line and also connected in parallel to the capacitive element.

3. A method of detecting abnormality of a relay for a power supply control device including:
a first DC power supply and a second DC power supply;
a first power line and a second power line;
a first relay Which connects between one electrode of the first DC power supply and the first power line;
a second relay which connects between the other electrode of the first DC power supply and the second power line;
a capacitive element which connects between the first power line and the second power line;
a converter which is connected between the first and second power lines and the second DC power supply;
a discharge speed reducing unit which reduces a discharge speed of discharge current flowing to the converter from the capacitive element;
a voltage sensor which detects a voltage between both terminals of the capacitive element; and
a control unit which controls switching of each of the first and second relays, controls an operation of the converter, and determines whether or not the first relay or the second relay is abnormal based on a voltage signal inputted from the voltage sensor, the method comprising:
controlling the converter so as to charge the capacitive element to a predetermined voltage higher than a voltage of the first DC power supply; and
thereafter in a state that the first and second relays are placed in a mutually opposite on/off state and the converter is turned off determining whether or not one of the first and second relays in the off state is abnormal based on change of a voltage value detected by the voltage sensor.

4. The method of detecting abnormality of a relay according to claim 3, wherein
discharge speed reducing unit is a resistor Which is connected between the first power line and the second power line and also connected in parallel to the capacitive element.
